(19) United States
(12) Patent Application Publication
(10) Pub. No.: US 2013/0332257 A1
(43) Pub. Date: Dec. 12, 2013

(54) SHARING PRIVATE DEVICES FOR CONTENT RENDERING

(71) Applicants: Charles C. Scheinost, Forest Knolls, CA (US); Amit Kishnani, Foster City, CA (US); Mike Harris, Santa Rosa, CA (US); Mark Rausch, San Francisco, CA (US); Bruce Bowman, San Jose, CA (US)

(72) Inventors: Charles C. Scheinost, Forest Knolls, CA (US); Amit Kishnani, Foster City, CA (US); Mike Harris, Santa Rosa, CA (US); Mark Rausch, San Francisco, CA (US); Bruce Bowman, San Jose, CA (US)

(73) Assignee: Adobe Systems Incorporated, San Jose, CA (US)

(21) Appl. No.: 13/492,654

(22) Filed: Jun. 8, 2012

(51) Int. Cl. G06F 15/173; G06Q 30/02

(52) U.S. Cl. 705/14.36; 709/223

(57) ABSTRACT

An apparatus and method for accessing a voluntary pool of devices for remote content rendering is disclosed herein. A brokering device receives a request from a content provider device to render content on a device, the request including the content to be rendered and specifying a type of the device on which the content is to be rendered. The brokering device also receives availability conditions from a test device. The brokering device selects the test device in accordance with the request and the availability conditions. The test device is instructed to fulfill the content rendering request.

### FIELD

The present disclosure relates generally to displaying content. More particularly, the present disclosure relates to accessing private devices for content display.

### BACKGROUND

As electronic content consumption increases each year, the number and types of devices on which content can be consumed is also proliferating. There is a wide variety in the size, shape, operating systems, and/or content viewing applications of such devices. And the variety is ever increasing as new categories of devices are created capable of rendering and presenting content to users.

The proliferation of devices makes content development challenging. Content may render differently or perhaps not at all across different devices. Even the same device hardware with different software versions may render a given content differently. Ideally the content developer may wish to view a given developed content on every device available in the marketplace to ensure that the content renders properly. But this is not practical since each type of device would either need to be purchased or the content developer would need to know people who own each of the different devices and obtain their permission to use those devices to see how the content renders. Additionally, even if the content developer had access to the multitude of devices, it would be time intensive to load content, view rendering of the content, note how the content rendered, and verify device settings and other rendering-effecting conditions for each of the devices.

### BRIEF DESCRIPTION OF THE DRAWINGS

Some embodiments are illustrated by way of example and not limitations in the figures of the accompanying drawings, in which:

FIG. 1 illustrates an example system for accessing a voluntary pool of private devices to selectively render content thereon and to obtain information about how the content rendered according to some embodiments.

FIG. 2 illustrates an example block diagram showing details of any of the devices shown in FIG. 1 according to some embodiments.

FIGS. 3A-3C respectively illustrate portions of an example flow diagram implemented on the machines shown in FIG. 1 according to some embodiments.

FIGS. 4A-4B respectively illustrate block diagrams showing the functionalities and operations of FIGS. 3A-3C implemented by modules according to some embodiments.

FIG. 5 shows a diagrammatic representation of a machine in the example form of a computer system within which a set of instructions, for causing the machine to perform any one or more of the methodologies of FIGS. 3A-3C and 4A-4B according to some embodiments.

The headings provided herein are for convenience only and do not necessarily affect the scope or meaning of the terms used.

### DETAILED DESCRIPTION

The following description is presented to enable any person skilled in the art to create and use a computer system configuration and related method and article of manufacture to broker content rendering request from a first device to be fulfilled on a second device. In some embodiments, the second device is selected from a global grid of devices that have volunteered to serve as content rendering test devices under pre-specified availability conditions. The second device is remotely directed to render one or more content in a certain way, and the second device is further directed to collect information about how it is rendering the content and report such information to the broker. The requester on the first device specifies the content to be rendered and the devices (or types of devices) on which the content should be rendered.

Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that embodiments of the invention may be practiced without the use of these specific details, in other instances, well-known structures and processes are not shown in block diagram form in order not to obscure the description of the invention with unnecessary detail. Thus, the present disclosure is not intended to be limited to the embodiments shown, but is to be accorded the widest scope consistent with the principles and features disclosed herein.

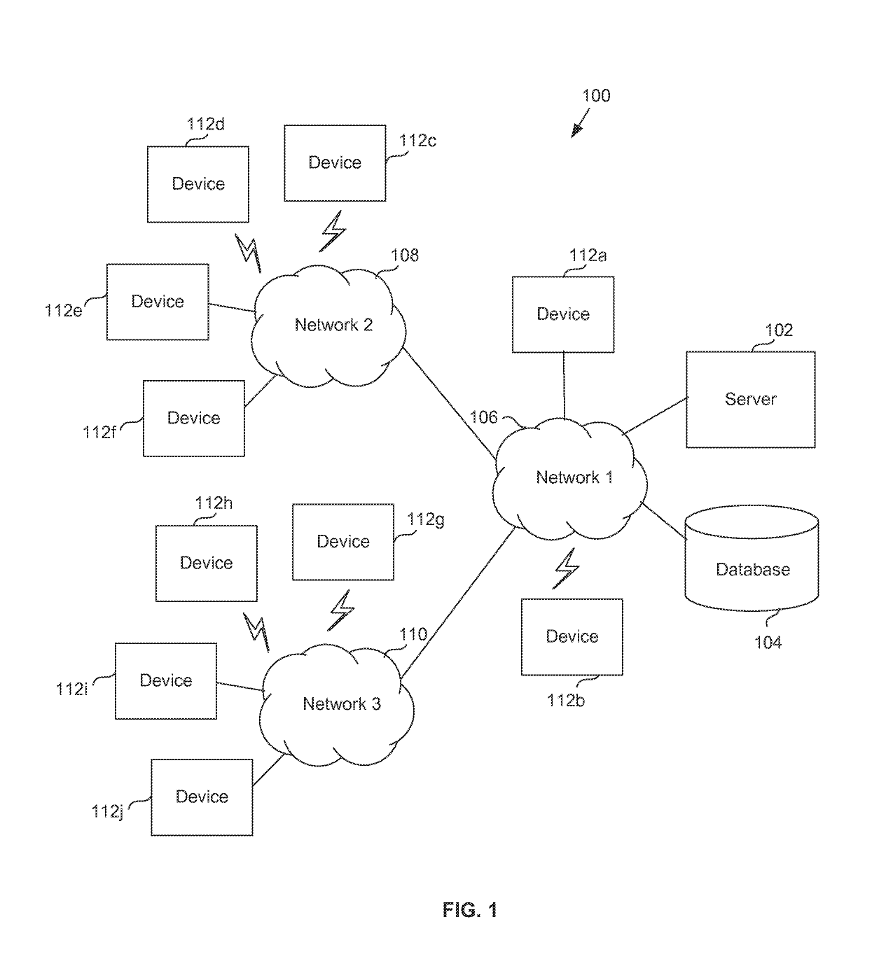

FIG. 1 illustrates an example system 100 for accessing a voluntary pool of private devices to selectively render content thereon and obtain information about how the content rendered according to some embodiments. System 100 includes a server 102, a database 104, a first network 106, a second network 108, a third network 110, and a plurality of devices 112a-112 (devices 112a-112j are collectively referred to as devices 112 and individually as a device 112). Each of the server 102, database 104, device 112a, and device 112b is in communication with the first network 106. Each of the devices 112c, 112d, 112e, and 112f is in communication with the second network 108. Each of the devices 112g, 112h, 112i, and 112j is in communication with the third network 110. The first network 106 is in communication with each of the second network 108 and third network 110.

The server 102 comprises a computing device including one or more processors configured to broker access to the voluntary pool or grid of private devices 112. The server 102 (also referred to as a broker server or broker computing device) is configured for communication with each of the database 104, device 112a, and device 112b via the first network 106. The server 102 is further configured for communication with devices 112c, 112d, 112e, and 112f via the first and second networks 106, 108, and with devices 112g, 112h, 112i, and 112j via the first and third networks 106, 110. The server 102 includes one or more applications, security protocols, communication capabilities, and information about the devices 112 to facilitate the broker functions described in detail below.

The database 104 comprises an information storage device configured to store information about the devices 112 (e.g., device model number, its operating system version, firmware version, carrier information, IP address, connection history, device parameter settings, etc.), content rendering instructions, a queue of content render requests, secure connection information (e.g., security tokens), developed content, incentivization rules, and other information associated with accessing the devices 112. The server 102 accesses the information stored in the database 104 and provides information for storage to the database 104. Although the database 104 is shown accessed via the first network 106, it is understood that a direct communication line may exist between the server 102 and database 104. Alternatively, the database 104 may comprise a part of the server 102.

The server 102 and database 104 can be geographically co-located or distributed from each other. Although a single server 102 and a single database 104 are shown in FIG. 1, it is understood that one or more of server 102 and/or one or more of the database 104 can be included in the system 100.

Each of the devices 112 comprises a computer or computing device, including but not limited to, work stations, personal computers, general purpose computers, Internet appliances, Internet-enabled televisions, Internet-enabled entertainment systems, hand-held devices, wireless devices, mobile devices, wearable computers, cellular or mobile phones, portable digital assistants (PDAs), smart phones, tablets, multi-processor systems, microprocessor-based or programmable consumer electronics, game consoles, set-top boxes, network PCs, mini-computers, ultrabooks, laptops, netbooks, and the like. The devices 112 comprise a variety of different types of devices different from each other in hardware, firmware, software, operating system, platform, service packs, web browser, content viewing applications, and/or the like. For example, device 112c can be a device running a particular version of the iOS operating system, device 112d can be a device running a particular version of the Android operating system, white device 112e can be an Internet-enabled television. More or less than two of the devices 112 may communicate over the first network 106; more or less than four of the devices 112 may communicate over the second network 108; and more or less than four of the devices 112 may communicate over the third network 110. As an example, hundreds or thousands of different types of devices may be represented by the devices 112.

Each of devices 112a, 112b communicates with the server 102 via the first network 106. Each of devices 112c, 112d, 112e, 112f communicates with the server 102 via the first and second networks 106, 108. Each of devices 112g, 112h, 112i, 112j communicates with the server 102 via the first and third networks 106, 110. Devices 112 may be geographically distributed or co-located with each other and/or from the server 102.

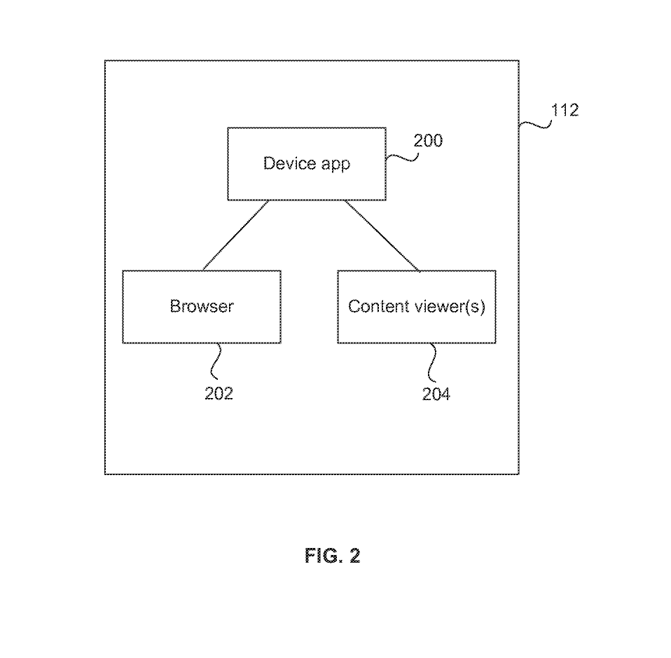

As shown in FIG. 2, each of the devices 112 includes a device application or device app 200, a device native browser 202 (e.g., web browser application such as INTERNET EXPLORER, FIREFOX, SAFARI, CHROME, etc.), and one or more device content viewers 204 (e.g., Adobe Acrobat, Adobe FlashPlayer, Adobe Ideas, EPUB reader, FOLIO reader). The device app 200 is installed on each of the devices 112 that wishes to participate in the voluntary pool of devices. The device app 200 can be downloaded from an appropriate e-commerce site associated with the type of device 112 or from the server 102. For example, for an Android-type of device, the device app 200 may be provided by an Android Market Place e-commerce site, whereas an iOS-type of device may obtain its device app 200 from iTunes. The browser 202 may differ from one type of device to another. For example, Safari may be the native browser for an iOS device while Chrome may be the native browser for an Android device. Similarly, the content viewer 204 may differ from one type of device to another.

Each of the first, second, and third networks 106, 108, 110 comprises a communications network, such as a local area network (LAN), a wireless LAN (WLAN), a wide area network (WAN), a wireless WAN (WWAN), a metropolitan area network (MAN), an ad hoc network, an intranet, an extranet, a virtual private network (VPN), a WiFi network, a WiMax network, a portion of the Internet, the Internet, a portion of a public switched telephone network (PSTN), a cellular network, or a combination of two or more such networks. Each of the first, second, and third networks 106, 108, 110 comprises a wired or wireless network. Each of the first, second, and third networks 106, 108, 110 can comprise a private, proprietary, or public network. For example, the first network 106 may comprise at least a portion of the Internet, the second network 108 a cellular network accessible through a contract with a particular carrier, and the third network 110 a home WiFi network. As another example, the first network 106 may comprise a public network, and each of the second and third networks 108, 110 comprising a private network that is incompatible with each other. In any case, the devices 112 communicate with the server 102 using, for example, Transmission Control Protocol/Internet Protocol (TCP/IP). More or less than three networks may be included in the system 100.

Further, while the system 100 shown in FIG. 1 employs a client-server architecture, embodiments of the present disclosure is not limited to such an architecture, and may equally well find application in, for example, a distributed or peer-to-peer architecture system.

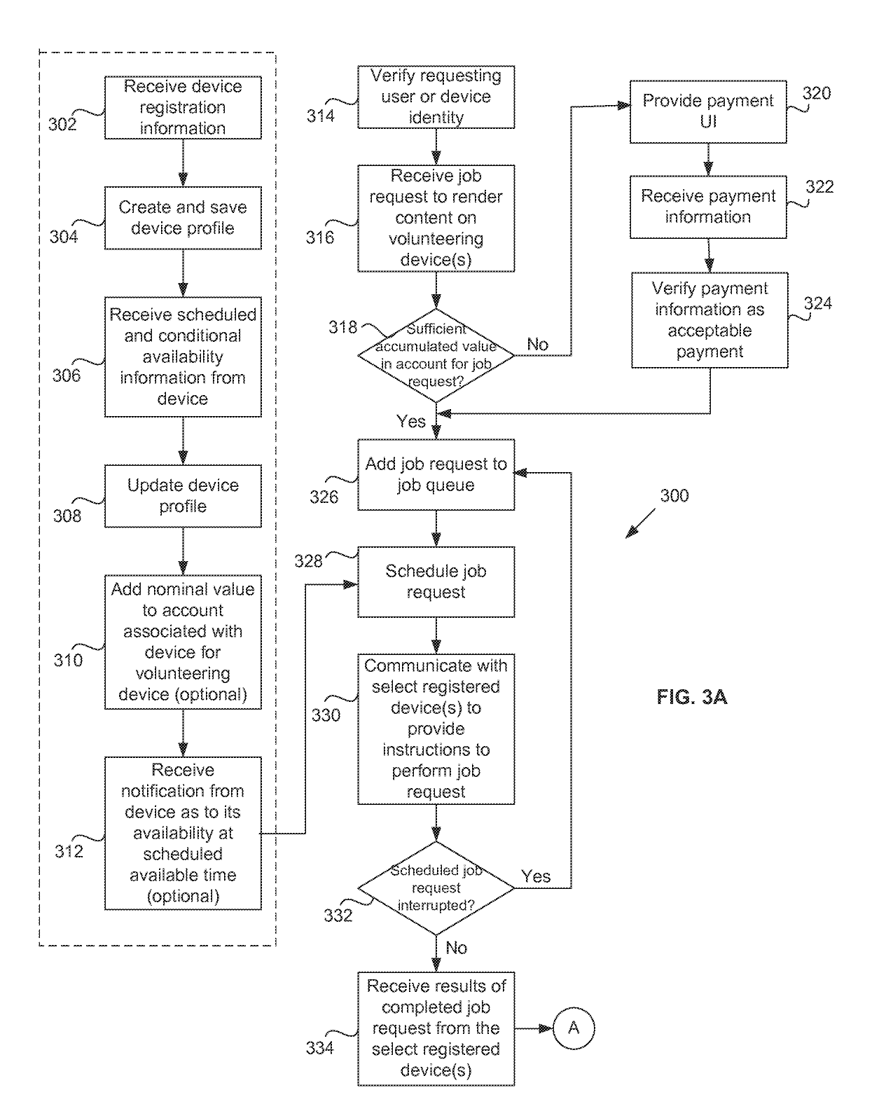

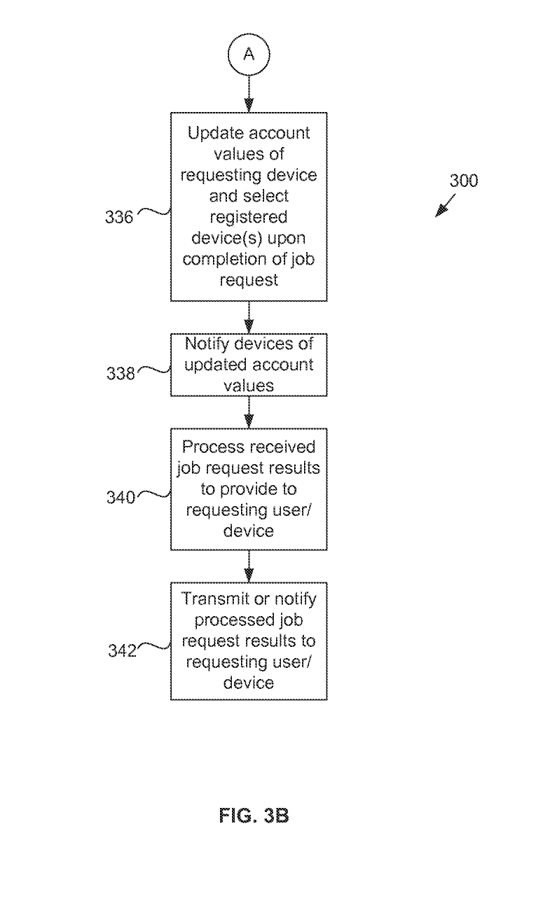

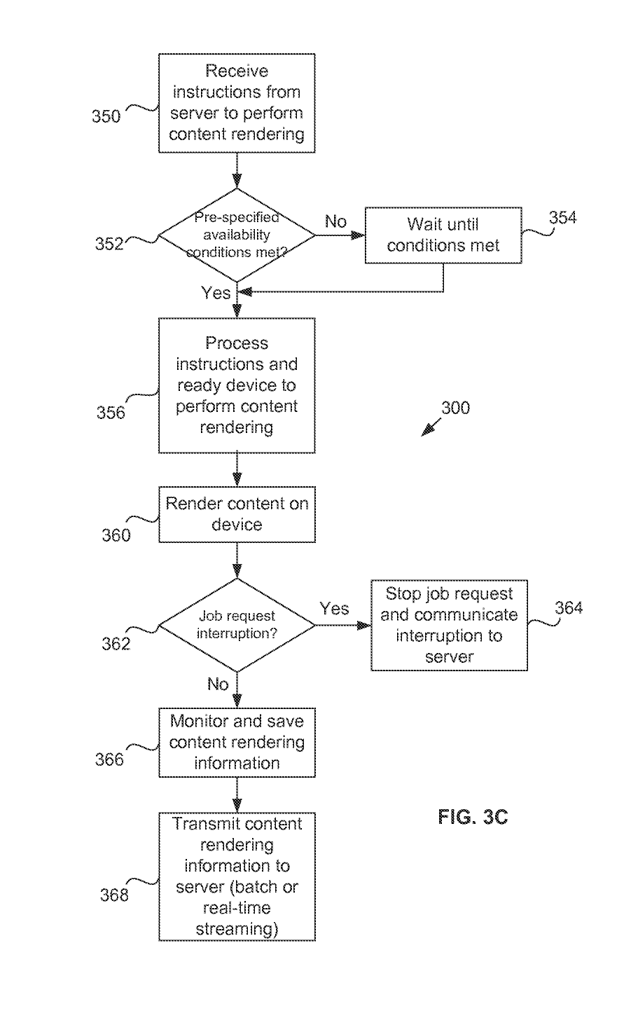

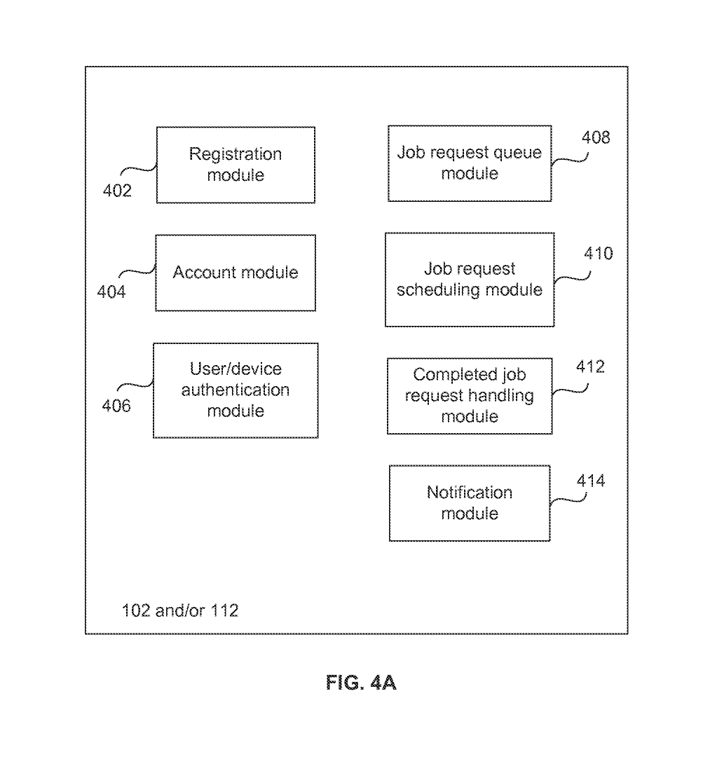

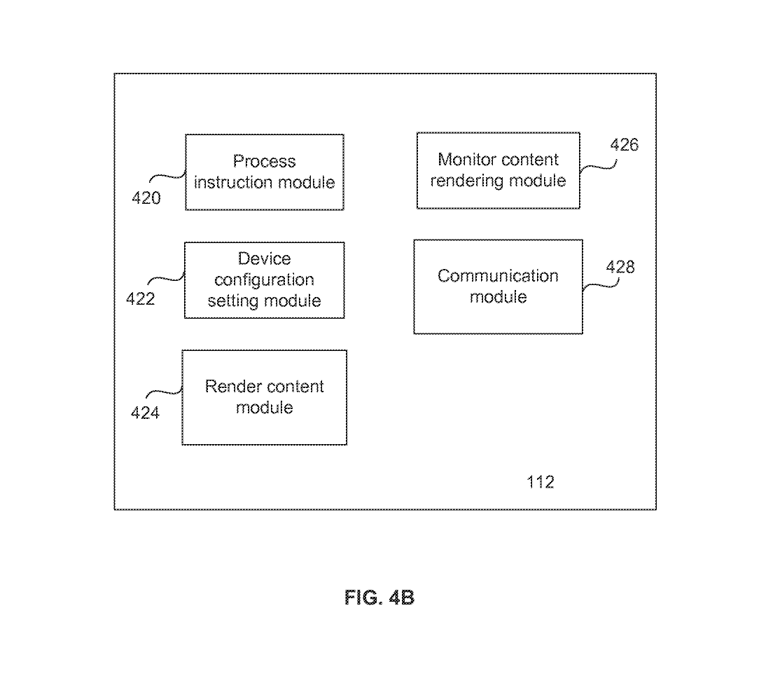

FIGS. 3A-3C respectively illustrate portions of an example flow diagram 300 showing functionalities and operations for participating in and coordination of a voluntary pool of devices accessible for rendering content according to some embodiments. A portion of the flow diagram 300 shown in FIGS. 3A-39 may be performed by the server 102, while the portion of the flow diagram 300 shown in FIG. 3C may be performed by any of the devices 112. FIGS. 4A-4B respectively illustrate block diagrams showing the functionalities and operations of FIGS. 3A-3C implemented by modules according to some embodiments. FIGS. 3A-3C and 4A-4B are described below in conjunction with each other.

The modules shown in FIGS. 4A-4B comprise one or more software components, programs, applications, apps, application programming interfaces (APIs), or other units of code base or instructions configured to be executed by one or more processors included in the device 112 and/or server 102 to provide the participation and coordination functionalities or operations described herein. In some embodiments, the modules are downloaded from an e-commerce site appropriate for the type of computing device. For example, if the device 112 comprises an iOS-type device (e.g., iPhone or the iPad), then the modules (which can be packaged as part of the device app 200 (see FIG. 2)) can be downloaded from iTunes. Similarly, if the device 112 comprises an Android-type device, then the modules (which can be packaged as part of the device app 200 (see FIG. 2)) can be downloaded from the Android Marketplace. The device 112 has communication capabilities with servers or databases at a remote location (e.g., server 102, database 104) to access data and/or processing capabilities, as needed, to carry out the functionalities and operations described below.

In other embodiments, the modules may be hosted on a server (e.g., server 102) and no download of the modules is required on the devices 112. Instead, the modules may be accessed by any of the devices 112 using a web browser over the first network 106. In still other embodiments, some of the modules may be included in the devices 112 while other of the modules may be included in the server 102; the device 112 communicating with the server 102 (and other possible servers) to together implement the participation and/or coordination functionalities. Although modules 400-428 are shown as distinct modules in FIGS. 4A-4B, it should be understood that modules 400-428 may be implemented as fewer or more modules than illustrated. It should also be understood that any of modules 400-428 may communicate with one or more components included in the system 100, such as the database 104, and/or other components not shown in system 100, such as a third party web server.

In one embodiment, the modules of FIG. 4A include a registration module 402, an account module 104, a user/device authentication module 406, a job request queue module 408, a job request scheduling module 410, a completed job request handling module 412, and a notification module 414. The modules of FIG. 4A are generally associated with the portion of the flow diagram 300 shown in FIGS. 3A-3B and are implemented at the server 102. The modules of FIG. 4B include a process instruction module 420, a device configuration and settings module 422, a render content module 424, a monitor content rendering module 426, and a communication module 428. The modules of FIG. 4B are generally associated with portion of the flow diagram shown in FIG. 3C and are implemented at the device app 200 included in the device 112.

FIGS. 3A-3B shows example functionalities or operations associated with the server 102 in order for devices 112 to participate in the pool of volunteering content rendering devices and to broker rendering of content on certain of the devices 112. The server 102 serves as a central clearinghouse, middleman, broker, or facilitator between a user (e.g., a content developer) at a device requesting content to be rendered and one or more devices (from among the pool of volunteering content rendering devices) on which the specified content is to be rendered.

At a block 302, the registration module 402 is configured to receive registration information from a device 112. The user of the device 112 voluntarily registers his or her device for inclusion to a pool or grid of devices available for content rendering. Registration information may include, but is not limited to, device information (e.g., manufacturer, model name, model number, device configuration and settings), a unique device identifier, operating system and version, device firmware version, device preferences, memory capacity, screen resolution, browser version, browser settings/preferences, and other information relating to adding a device to the pool of available devices. The device app 200 included in the device 112 may provide one or more registration user interface (UI) screens to specify and accept the registration information. Alternatively, the user may access the registration UI screens provided on a website hosted by (or is associated with) the server 102 to provide the requisite registration information. In some embodiments, some of the registration information can be provided directly by the user of the device 112 while other of the registration information is provided automatically by the device 112 without user input. The registration module 402 is configured to create and save a device profile associated with the particular device 112 in accordance with the received registration information (block 304).

The particular device 112 is making itself available to be a test device when it is not in use (and in accordance with user-specified availability conditions). The particular device 112 donates or offers idle resources to a global grid of devices. The rest of the time the particular device 112 comprises a privately-owned device that is maintained and operated independently of the server 102, the pool of devices, and any user or device that may request test time on the particular device 112.

Next at a block 306—which can occur in the same session or a different session from registration of the particular device 112—the registration module 402 is configured to receive scheduling information (also referred to as availability information or availability conditions) from the device 112 relating to its availability for rendering content and any restrictions or conditions associated with its availability. For example, the device 112 may specify that it is available for use under the following conditions: between the hours of midnight and 6 AM, when the device is turned on, the device is connected to the user's home wireless network, the device is connected to a charger, and the device is not in use. A variety of other availability conditions can be received from the device 112. The device app 200 included in the device 112 may provide one or more scheduling UI screens to specify scheduling or availability conditions. Alternatively, the user may access the scheduling UI screens provided on a website hosted by (or is associated with) the server 102 to specify the scheduling or availability conditions.

In some embodiments, more than one set of scheduling information can be associated with a particular device 112. A trusted network of devices or users (also referred to as a trusted social circle) can be designated, whose members are subject to a different set of scheduling or access rules than those outside of such a trusted network. For instance, the scheduling or access rules for the trusted network may be less restrictive than the rules for those outside the trusted network; the result being that users that are members of the trusted network are more likely to obtain content rendering time on the particular device 112. Hence, the scheduling feature can incorporate different levels of trust and friendship in association with determining access to the particular device 112.

It is understood that the registration module 402 can receive updates to the availability conditions from the user of the particular device 112 at the block 306 after the initial availability conditions are provided by the user.

At a block 308, the registration module 402 is configured to update the device profile associated with the particular device 112 with the received scheduling information (one or more sets as discussed above).

Since participation in the pool of available devices is voluntary, the account module 404 may be configured to incentivize the particular device 112 to register and/or provide scheduling information at a block 310. The account module 404 can configure an account associated with the particular device 112 and add value (e.g., in a commercial currency, such as the U.S. dollar, or a proprietary currency, such as “points”) to that account for volunteering the device. Value can accumulate in the account that can be later redeemed for requesting rendering of content on other devices. The amount of value added to the account may be a nominal value for each device that volunteers, or the value may differ based on the type of device. For example, a brand new device, for which there are few or none in the pool, may receive a higher amount of value than a device type for which a large number have already volunteered. Alternatively, block 310 may be omitted and there is no incentive provided for registering and/or providing scheduling information.

Once the particular device 112 has registered and specified availability conditions, the notification module 414 and/or the user/device authentication module 404 is configured to receive notification from the particular device 112 that it is ready to receive a job request to render content (block 312). This notification is received when the device 112 determines that its specified availability conditions are satisfied. The notification can also include handshake information, device identification information, or other authentication information. The notification may be referred to as communication of a testing-ready status. Alternatively, block 312 may be omitted in other embodiments. Since the registration module 402 knows the availability conditions for the particular device 112, it can determine when the particular device 112 is available to accept job requests to render content. If the registration module 402 is able to make the determination, the device 112 need not send notification when it becomes available.

Blocks 302-312 are repeated for each device 112 that volunteers to be added to the pool of available devices. Each of the devices 112 that volunteers to be included in the pool of devices is also referred to as a volunteering device, a participating device, a test device, a registered device, a content rendering device, or other similar terms.

At a block 314, the user/device authentication module 406 is configured to receive and verify the identity of a user (e.g., a content developer or tester) or device that wishes to make a request to have content rendered on certain devices or a certain class/type of devices. Such a device may be referred to as a requesting device or content provider device. The user or device may have previously registered with the server 102 or otherwise established a unique identity recognizable by the server 102. For example, the user/device authentication module 406 receives a username and password that is checked against a database or file of login identities, such as in database 104.

The requesting device may be a device that registered with the server 102 to participate in the pool of devices (e.g., the requesting device is also a tester device) or a device that is not registered as a participating device in the pool. The requesting device may not require installation of the device app 200 (see FIG. 2) if the requesting device is not participating in the pool of devices and the functionalities/operations relating to requesting content to be rendered is fully web-enabled at the server 102. Alternatively, the requesting device (regardless of whether it is also participating in the pool of devices) may include the device app 200 that provides screens, access to functionalities/operations at the server 102, or otherwise facilitates making a request for content to be rendered on certain (class of) devices.

Once the user or device identity is verified, the job request queue module 408 is configured to receive a job request from the user/requesting device requesting content to be rendered on one or more certain devices or certain class(es) of devices (block 316). For instance, a person developing website wants to test rendering of the website on certain devices (or certain types of devices) but does not have access to such devices. The person contacts a broker or clearinghouse to obtain access to a pool of available devices. The person requests testing time on certain devices (or certain types of devices) and specifies the testing parameters. Such a request is referred to as a job request.

A job request includes specification of the content to be rendered. For example, the job request may specify one or more uniform resource locators (URLs) or one or more files of images, photos, video, print media, web pages, web site, visual asset, etc. (collectively referred to as “visual content”). The job request may also specify what type of device(s) the content should be rendered on. The user may select from along the pooled devices, or the user may specify the type of device. For example, the user may specify rendering on all versions of iPads, devices running Android release 3.X Honeycomb operating system, or other classes/types of devices. Depending on the device type(s) specified by the job request, a given job request can result in content being rendered on one or more of devices 112. The job request may also specify one or more actions that should be taken on the content (e.g., click on certain links included in a webpage corresponding to a URL). The job request may also include other testing parameters such as, but not limited to, a time at which the test needs to be completed, desired rendering monitoring statistics, devices operating on specific carrier(s), devices operating in certain language(s), devices operating in a certain geographical area, and the like.

Before fully accepting the job request, the account module 404 is configured to check if the account associated with the requesting device (or a requesting user) has enough accumulated value to redeem for the job request (block 318). If the account value is insufficient, then the requesting device can still have its job request fulfilled by paying for the service. The account module 404 provides one or more payment UI screens for the user to enter payment information (block 320). Payment information can include credit card, debit card, Paypal, or other acceptable methods of payment information and authorization to charge or deduct a certain amount from the entered method of payment. Upon receiving such payment information at a block 322, the account module 404 checks whether the received payment information is valid at a block 324. This check may include interfacing with a financial institution or clearinghouse to verify the validity of the account and sufficiency of funds in that account. Once the payment information has been validated, the job request is fully accepted and is added to a job queue at a block 326.

Alternatively, blocks 320, 322, 324 may be omitted if the “currency” for requesting a job request is the requesting user/device having an account with sufficient entitlements (e.g., accumulated value) associated with it.

The server 102 may assign different value to different job requests. For example, the greater the number of content to be rendered in a job request may increase the price of fulfilling that job request. As another example, requesting rendering on a higher value assigned type of device may increase the price of fulfilling that job request. This and other value assignment rules can be implemented to assign specific value to each of the received job requests, so that sufficiency of accumulated value in the account associated with the requesting device can be determined (and payment requested if the value in the account is insufficient).

If there is sufficient value or funds in the account associated with the requesting device or the requesting device has provided payment to address the shortfall in its account, the job request queue module 408 adds the job request to a job queue (block 326). Next at a block 328, the job request scheduling module 410 is configured to schedule the job request for fulfillment, including processing the job request to determine which of the device(s) from among the pool of devices are available and suitable to fulfill the job request in accordance with the job request and the availability conditions specified by the registered devices. Scheduling or prioritizing a job request is based on one or more criteria such as, but not limited to, taking into account other job requests in the queue, a job request that contains multiple tests or requests for tests on multiple devices may take longer to process, the requesting user/device may be associated with a certain tier of service, and the like. Regarding different tiers of service, for example, a requesting user/device associated with a higher tier of service may have his/her job requests inserted into a higher position in the job queue or into a separate higher priority job queue. The requesting user/device may be able to specify a queue priority based on what he/she is willing to “pay” —a premium cost equates to higher priority and a discounted cost equates to a lower priority.

Then at a block 330, the job request scheduling module 410 (remotely) communicates with each of the device(s) selected to fulfill the job request, including providing instructions (and data) to each of the selected device(s). The communication can be one-way or two-way communication with the device(s). As an example, the communication may include a handshake process between the server 102 and each of the selected device(s), as well as one or more communication pathways directly pertaining to transmission of the job request instructions to the selected device(s). The transmitted instructions include, but are not limited to, the content to be rendered, rendering actions to be taken (if specified in the job request), device settings or configurations (if specified in the job request), device identifier, job request identifier, and other commands to fulfill the job request.

In some embodiments, the communication can include establishing a secure, trusted connection between the server 102 and each of the selected device(s). A trusted connection is secured between the server 102 and each of the selected device(s) by exchanging a set of security keys (also referred to as security code or tokens) indicating that a given pair of machines is allowed to communicate with each other. In a given pair of machines, the server 102 and the device independently obtains information about its environment, machine state, etc. to determine what a successful security key should be. This code or token is exchanged between the server 102 and the device.

While the job request is being fulfilled or executed by the selected device(s), if an indication of a job request interruption is received from a device (block 332), then the job request is deemed to be unfulfilled and that job request returns to the job queue for rescheduling (returns to block 326). As an example, a job request interruption can arise if a user of one of the selected device(s) starts using the device while the device is testing rendering of content. Such action overrides the test in progress to provide the user (possibly the owner of the device) full access to his/her device. In one embodiment, a job request interruption indication from one of the selected device(s) may be sufficient to return the entire job request to the job queue for rescheduling. In another embodiment, a job request interruption indication from one of the selected device(s) may render the testing on that device to be nullified but not on the remaining selected device(s). The portion of the job request pertaining to the single interrupted device may be returned to the job queue for rescheduling.

If there are no interruptions during the testing period, then the completed job request handling module 412 is configured to receive test results, test reports, test statistics, or other information about how the content rendered on each of the selected device(s) instructed to render content (block 334). The information can be received in batch format upon completion of the test or in real-time (or near real-time) streaming format while the test is in progress. The information received by the module 412 can include video captures, screenshot captures, metadata, memory consumption statistics, rendering time statistics, other statistics, network loading times for assets, rendering times for display visual elements, and the like (collectively referred to as content rendering statistics).

Once the job request has been fulfilled and the content rendering statistics are received by the server 102, the account module 404 is configured to update the accounts associated with each of the requesting device and the selected device(s) that served as test devices (block 336). For the requesting device, certain value may be deducted from its account or payment may be charged. For the selected device(s), certain value may be added to their accounts. As discussed above, different devices may receive different value (e.g., a brand new or scarce device may accumulate more value than an older or commonplace device). Accumulation of value in an account provides status within the developer community, serves as an incentive to continue participating in the pool of available devices, can be redeemed to access devices for testing content rendering, or may be monetized (e.g., redeemed for other products, services, or money).

At a block 338, the notification module 414 is configured to provide notification to the requesting device and selected device(s) regarding updates to their respective accounts. The notification may be any form of communication including electronic mail (e-mail) or text messages. The completed job request handling module 412 processes the received content rendered results into a format or package desirable to the user/requesting device that submitted the job request (block 340). The user may request the results in a certain package or the notification module 414 may determine a certain package based on the content rendered results.

Lastly at a block 342, the completed job request handling module 412 and/or the notification module 414 is configured to transmit or notify the user or requesting device that the content rendered results from the test devices are processed and ready for consumption. The processed results can be e-mailed or it may be downloaded from the server 102.

Thus, devices 112 (and other devices not shown in FIG. 1) report to the server 102, and the server 102 acts as a broker between a device requesting access to private devices to render content thereon and one or more private devices serving as test devices for the requesting device. It is understood that one or more of the blocks of FIGS. 4A-4B can be performed in different order or simultaneously with each other. For example, blocks 336 and 340 may be performed simultaneously with each other. As another example, blocks 338 may be performed after block 340. These and other variations are contemplated within the embodiments of the present disclosure.

The portion of the flow diagram 300 shown in FIG. 3C is performed after block 330 (FIG. 3A) and before block 334 (FIG. 3A) by each of the device(s) selected by the server 102 to fulfill the job request. At a block 350, the process instruction module 420 included a given selected device (e.g., the process instruction module 420 being included in the device app 200 (FIG. 2)) is configured to receive instructions from the server 102 to perform content rendering. The received instructions correspond to the instructions described above with respect to block 330 (FIG. 3A).

The process instruction module 420 is further configured to check whether all of the availability conditions associated with the given selected device are satisfied at a block 352. If the one or more of the availability conditions are not satisfied, then the given selected device waits until all conditions are met (block 354). Otherwise all the conditions are satisfied and content rendering may commence at a block 356.

At the block 356, the process instruction module 420 and/or the device configuration setting module 422 are configured to process the received instructions to ready the given selected device to begin rendering the specified content. The particular device 112 determines what application is appropriate for rendering the content, such as the browser 202 or a particular one of the content viewers 204 (FIG. 2). The particular device 112 also determines how the content should be rendered. The received instructions may also command the particular device 112 to normalize or otherwise specify certain device settings for purposes of rendering the test content. For example, the user of the particular device 112 may have configured his/her browser settings as to when or what cached information is to be cleared. During test time, however, the browser setting can be different from the user settings. Such browser settings may differ from the user settings as specified by the user requesting the job request or as determined by the server 102 (e.g., settings that facilitate accurate testing of content rendering on a given device 112).

The command instructing the particular device 112 to achieve certain device settings or state includes, for example, command to clear cache and cookies and/or to render in a particular screen orientation. For instance, in the case of content comprising a URL, when the device's cache and cookies are cleared, the user is ensured that the web content rendering on the device is the same version of the web content currently requested to be rendered. Otherwise, different versions of the web content corresponding to the URL that was previously rendered on the device may be saved in the device's cache and cookies, and the device may access a locally saved older version of the web content rather than requesting the latest version from the source specified by the URL.

Next at a block 360, the render content module 424 facilitates rendering of test content on the particular device 112. If the content comprises a URL, the browser 202 included in the device 112 is launched and the received URL is provided to the browser 202. The browser 202 retrieves the web content (e.g., web page, web site, etc.) corresponding to the URL and renders it on the display of the device 112. The web content is hosted on a web server (public facing or behind a firewall) or on the server 102. For example, if the device 112 is an iOS device, its native web browser may be Safari. As another example, if the device 112 is an Android device, its native web browser may be Chrome. If the content comprises a file of an image, video, print media, web page, website, visual asset, etc., the appropriate content viewer 204 included in the device 112 is launched and it renders such content for display on the device 112.

During the test period, if an interruption occurs (block 362), then the rendering stops and the communication module 428 communicates the stoppage to the server 102 (block 364). As discussed above with respect to block 332, the interruption comprises an action pertaining to the device 112 that is incompatible with the device serving as a test device at that point in time. For example, if the user starts using the device 112 while the device is rendering test content, then the rendering stops and the job request is cancelled for that device 112. As another example, if the availability conditions associated with the device 112 are no longer satisfied, then the job request in progress is stopped and cancelled.

Throughout the test period, the monitor content rendering module 426 is configured to monitor, capture, and save metrics pertaining to how the content is rendering on the device 112 (block 366). The capture of such test metrics or statistics can include video capture, screen capture, measuring the time it takes for each content to render, and the like. At a block 368, the information relating to how the content is rendering on the device 112 is transmitted to the server 102 by the communication module 428. The transmission may be in a batch fashion after the job request has been completed on the device 112 or streamed in real-time (or near real-time) while the job request fulfillment is in progress on the device 112.

It is contemplated that block 360 can occur simultaneously with block 366 and/or block 368. It is also contemplated that blocks 356 and 360 can occur simultaneously with each other, especially where processing of the instructions includes processing instructions relating to rendering of a plurality of content. These and other variations are within the scope of the present disclosure.

Although each of the devices 112 selected to be a test device for a given job request receives and renders the content, the user/owner of these devices 112 do not have access to such content. The user may be aware that rendering of content occurred (perhaps when notified of points/values added to his/her account), but he/she would not have access to the content that was rendered, the test results, or even who requested the content to be rendered. Privacy of the user/requesting device is maintained. Similarly the privacy and anonymity of the devices on which the test content was rendered are also maintained from the user/requesting device perspective. The requesting device and test device are anonymous to each other.

In this manner, an ecosystem is provided for brokering access to a grid of private devices for rendering content thereon. A first device requests specific content to be rendered on specific devices or types of devices. A broker server determines the availability of devices from among a grid of devices that volunteered to participate as test devices. One or more second devices from among the grid of devices are remotely directed to render the specific content in a certain way. The second devices capture information about how they are rendering the content and provide such information to the broker server. The broker server, in turn, processes the received information suitable for providing to the first device. Incentives are provided in this ecosystem to incentivize devices to participate in the grid of devices and to fulfill content rendering requests.

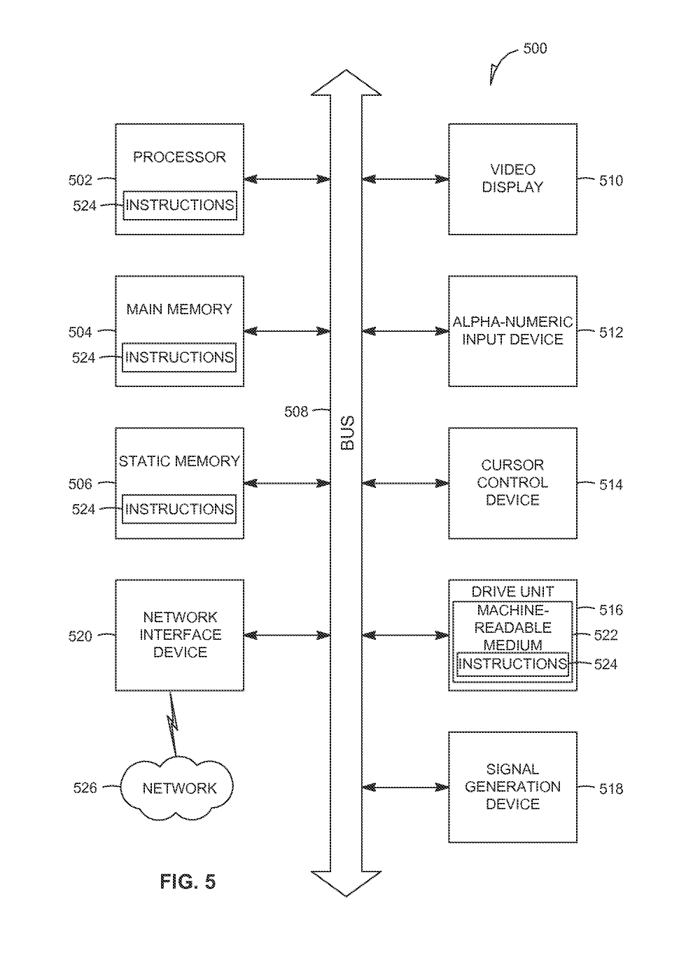

FIG. 5 shows a diagrammatic representation of a machine in the example form of a computer system 500 within which a set of instructions, for causing the machine to perform any one or more of the methodologies discussed herein, may be executed. As an example, the computer system 500 may comprise any of the server 102 and/or devices 112. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet, a set-top box (STB), a Personal Digital Assistant (PDA), a smart phone, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., liquid crystal display (LCD), organic light emitting diode (OLED), touch screen, or a cathode ray tube (CRT)). The computer system 500 also includes an alphanumeric input device 512 (e.g., a physical or virtual keyboard), a cursor control device 514 (e.g., a mouse, a touch screen, a touchpad, a trackball, a trackpad), a disk drive unit 516, a signal generation device 518 (e.g., a speaker) and a network interface device 520.

The disk drive unit 516 includes a machine-readable medium 522 on which is stored one or more sets of instructions 524 (e.g., software) embodying any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), non-transitory, or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the spirit and scope of the invention.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for facilitating a request to render content on a test device, the method comprising:
registering, at a server, the test device for inclusion in a plurality of devices that are selectively operable to serve as test devices for rendering content;
receiving, at the server, availability conditions associated with the test device, the availability conditions specifying one or more conditions under which the test device is available to fulfill requests to render content;
receiving, at the server, the request from a content provider device to render content on a device, the request including a first content to be rendered and specifying a type of the device;
scheduling, by the server, fulfillment of the request from the content provider device, the scheduling including selection of the test device from among the plurality of devices based on the received availability conditions and the request; and
remotely directing the test device to fulfill the request and to return to the server content rendering statistics associated with rendering of the first content on the test device, wherein the test device and the content provider device are anonymous to each other.

2. The method of claim 1, further comprising:
receiving, at the server, the content rendering statistics from the test device in response to rendering of the first content on a display included in the test device; and
providing to the content provider device at least a portion of the content rendering statistics.

3. The method of claim 1, wherein the content rendering statistics comprises an image screenshot or a video screenshot of the first content rendering on the test device.

4. The method of claim 1, wherein the first content comprises at least one of a uniform resource locator (URL), an image, a video, a print media, a web page, a web site, a visual asset, and a visual content.

5. The method of claim 1, wherein the request includes a second content to be rendered.

6. The method of claim 1, further comprising incentivizing the test device to register or fulfill the request by adding redeemable value points to an account associated with the test device.

7. The method of claim 1, further comprising determining sufficiency of an account associated with the content provider device to make the request, prior to scheduling fulfillment of the request.

8. The method of claim 7, wherein the account includes redeemable value points and the content provider device is included in the plurality of devices.

9. The method of claim 7, further comprising receiving payment information from the content provider device, when the account associated with the content provider device is determined to be insufficient, to purchase fulfillment of the request.

10. A system, comprising:
at least one storage device storing device information and executable instructions representing one or more modules; and
at least one processor in communication with the storage device and configured to execute the modules to:
register a test device for inclusion in a plurality of devices that are selectively operable to serve as test devices for rendering content, the device information stored in the storage device including information associated with registering the test device;
receive availability conditions associated with the test device, the availability conditions specifying one or more conditions under which the test device is available to fulfill requests to render content;
receive a request from a content provider device to render content on a device, the request including a first content to be rendered and specifying a type of the device;
schedule fulfillment of the request from the content provider device, the scheduling including selection of the test device from among the plurality of devices based on the received availability conditions and the request; and
remotely direct the test device to fulfill the request and to return to the processor content rendering statistics associated with rendering of the first content on the test device, wherein the test device and the content provider device are anonymous to each other.

11. The system of claim 10, wherein the content provider device is not among the plurality of devices.

12. The system of claim 10, wherein the storage device comprises a database, the processor is included in a server, the content provider device comprises at least one of a laptop, desktop, or workstation, and the test device comprises a mobile device.

13. The system of claim 10, wherein the processor is further configured to execute the modules to:
receive the content rendering statistics from the test device in response to rendering of the first content on a display included in the test device; and
provide to the content provider device at least a portion of the content rendering statistics.

14. The system of claim 10, wherein the content rendering statistics comprises an image screenshot or a video screenshot of the first content rendering on the test device.

15. The system of claim 10, wherein the first content comprises at least one of a uniform resource locator (URL), an image, a video, a print media, a web page, a web site, a visual asset, and a visual content.

16. The system of claim 10, wherein the request includes a second content to be rendered.

17. The system of claim 10, wherein the processor is further configured to execute the modules to incentivize the test device to register or fulfill the request by adding redeemable value points to an account associated with the test device.

18. The system of claim 17, wherein the redeemable value points vary depending on the type of the test device.

19. The system of claim 10, wherein the processor is further configured to execute the modules to determine sufficiency of an account associated with the content provider device to make the request, prior to scheduling fulfillment of the request.

20. The system of claim 19, wherein the account includes redeemable value points and the content provider device is included in the plurality of devices.

21. The system of claim 19, wherein the processor is further configured to execute the modules to receive payment information from the content provider device, when the account associated with the content provider device is determined to be insufficient, to purchase fulfillment of the request.

22. A non-transitory computer readable medium including instructions, when executed by a processor, causes the processor to perform operations comprising:
registering, at a server, a test device for inclusion in a plurality of devices that are selectively operable to serve as test devices for rendering content;
receiving, at the server, availability conditions associated with the test device, the availability conditions specifying one or more conditions under which the test device is available to fulfill requests to render content;
receiving, at the server, a request from a content provider device to render content on a device, the request including a first content to be rendered and specifying a type of the device;
scheduling, by the server, fulfillment of the request from the content provider device, the scheduling including selection of the test device from among the plurality of devices based on the received availability conditions and the request; and
remotely directing the test device to fulfill the request and to return to the server content rendering statistics associated with rendering of the first content on the test device, wherein the test device and the content provider device are anonymous to each other.

23. The non-transitory computer readable medium of claim 22, wherein the content rendering statistics comprises an image screenshot or a video screenshot of the first content rendering on the test device.

24. The non-transitory computer readable medium of claim 22, wherein the first content comprises at least one of a uniform resource locator (URL), an image, a video, a print media, a web page, a web site, a visual asset, and a visual content.

25. The non-transitory computer readable medium of claim 22, further comprising incentivizing the test device to register or fulfill the request by adding redeemable value points to an account associated with the test device.

26. The non-transitory computer readable medium of claim 22, further comprising determining sufficiency of an account associated with the content provider device to make the request, prior to scheduling fulfillment of the request.

27. A method for rendering content on a test device, the method comprising:
registering the test device to a server, for inclusion in a plurality of devices that are selectively operable to serve as test devices for rendering content;
providing, to the server, by the test device availability conditions specifying one or more conditions under which the test device is available to fulfill requests to render content;
receiving, at the test device, instructions from the server to render content on the test device, the instructions received in response to a request to render content originating from a content provider device and the availability conditions being satisfied, the request specifying a type of device to render a first content, wherein the test device comprises the type of device specified in the request;
rendering, on the test device, the first content in accordance with the received instructions; and
capturing, at the test device, information relating to how the first content renders.

28. The method of claim 27, further comprising transmitting the captured information to the server in at least one of a batch format or a streaming format.

29. The method of claim 27, further comprising:
detecting an interruption action during the rendering of the first content;
in response to the detected interruption action, stopping the rendering of the first content; and
communicating a stop to the rendering of the first content to the server.

30. The method of claim 29, wherein the interruption action comprises a user using the test device.

31. The method of claim 27, wherein the first content comprises at least one of a uniform resource locator CURL), an image, a video, a print media, a web page, a web site, a visual asset, and a visual content.

32. The method of claim 27, further comprising conforming device settings of the test device to render the first content, wherein the conformed device settings differ from user-specified device settings of the test device.

33. A test device, comprising:
at least one storage device including one or more modules;
a display; and
at least one processor in communication with each of the storage device and the display and configured to execute the modules including instructions to:
register the test device to a server, for inclusion in a plurality of devices that are selectively operable to serve as test devices for rendering content;
provide, to the server, availability conditions specifying one or more conditions under which the test device is available to fulfill requests to render content;
receive instructions from the server to render content on the test device, the instructions received in response to a request to render content originating from a content provider device and the availability conditions being satisfied, the request specifying a type of device to render a first content, wherein the test device comprises the type of device specified in the request;
render the first content in accordance with the received instructions on the display; and
capture information relating to how the first content renders.

34. The test device of claim 33, wherein the processor is further configured to execute the modules including instructions to transmit the captured information to the server in at least one of a batch format or a streaming format.

35. The test device of claim 33, wherein the processor is further configured to execute the modules including instructions to receive, from the server, a notification of redeemable value added to an account associated with the test device for rendering the first content.
